(19) United States
(12) Patent Application Publication
(10) Pub. No.: US 2017/0323206 A1
(43) Pub. Date: Nov. 9, 2017

(54) METHOD AND SYSTEM FOR DETERMINING A WEIGHT ALLOCATION IN A GROUP COMPRISING A LARGE PLURALITY OF ITEMS USING AN OPTIMIZATION ORACLE

(71) Applicant: 1QB INFORMATION TECHNOLOGIES INC., Vancouver (CA)

(72) Inventors: Elham ALIPOUR KHAYER, Vancouver (CA); Arman ZARIBAFIYAN, Vancouver (CA); Maxwell ROUNDS, Edmonds, WA (US); Marcos LOPEZ DE PRADO, Harrison, NY (US); Clemens ADOLPHS, Vancouver (CA)

(21) Appl. No.: 15/590,677

(22) Filed: May 9, 2017

Related U.S. Application Data
(60) Provisional application No. 62/333,484, filed on May 9, 2016.

(51) Int. Cl. G06N 5/02; G06F 17/30; G06N 99/00

(52) U.S. Cl. CPC G06N 5/022; G06N 99/002; G06F 17/30327; G06F 17/30598

(57) ABSTRACT

A method and a system are disclosed for determining a weight allocation in a group comprising a large plurality of items using an optimization oracle, the method comprising obtaining an indication of a plurality of data for each item of a large plurality of items; generating a covariance matrix for the plurality of data; generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters, translating the formulated optimization problem into an unconstrained binary optimization problem, providing an indication of the unconstrained binary optimization problem to an optimization oracle, receiving an indication of at least one solution from the optimization oracle, assigning a cluster to each item of the given set of items using the at least one solution; recursively determining a weight allocation for each item of the plurality of items using the covariance matrix and the generated hierarchical tree structure and providing an indication of the determined weight allocation for each item in the group comprising a plurality of items.

### CROSS-REFERENCE TO RELATED APPLICATION

The present patent application claims priority on U.S. Provisional Patent Application No. 62/333,484, filed on May 9, 2016.

### FIELD OF THE INVENTION

The invention relates to the use of optimization oracles. More precisely, the invention pertains to a method and system for determining a weight allocation in a group comprising a large plurality of items using an optimization oracle.

### BACKGROUND OF THE INVENTION

Being able to determine a weight allocation in a group comprising a large plurality of items is of great importance.

In finance, the determining of a weight allocation in a portfolio comprising a plurality of assets is of great interest.

One of the prior art methods used for solving this problem is a quadratic optimization method.

In those prior art methods, the whole portfolio optimization problem is modeled as a quadratic optimization problem.

Critical Line Algorithm (CLA) is an example of such prior art methods.

Unfortunately this method suffers from many drawbacks.

A disadvantage of this prior art method is that it may be unstable. More precisely, a portfolio obtained using this method may be unstable to numerical errors since the method uses the inverse of a covariance matrix.

Other disadvantages of this prior art method are that it may bring concentration and under-performance in a resulting portfolio.

The resulting portfolio is concentrated and may not be well diversified.

The resulting portfolio may also have a high risk associated with it.

There is a need for a method that will overcome at least one of the above-identified drawbacks.

Features of the invention will be apparent from review of the disclosure, drawings and description of the invention below.

### BRIEF SUMMARY OF THE INVENTION

According to a broad aspect, there is disclosed a method for determining a weight allocation in a group comprising a large plurality of items using an optimization oracle, the method comprising obtaining using a processor an indication of a plurality of data for each item of a large plurality of items; generating using the processor a covariance matrix for the plurality of data; generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters using the processor, translating using the processor the formulated optimization problem into an unconstrained binary optimization problem, providing using the processor an indication of the unconstrained binary optimization problem to an optimization oracle, receiving an indication of at least one solution from the optimization oracle using the processor, using the processor assigning a cluster to each item of the given set of items using the at least one solution; using the processor, recursively determining a weight allocation for each item of the plurality of items using the covariance matrix and the generated hierarchical tree structure; and providing using the processor an indication of the determined weight allocation for each item in the group comprising a plurality of items.

According to an embodiment, the indication of a plurality of data for each item of a large plurality of items is obtained from a user interacting with the processor.

According to an embodiment, the indication of a plurality of data for each item of a large plurality of items is obtained from a memory unit comprised in the processor.

According to an embodiment, the indication of a plurality of data for each item of a large plurality of items is obtained from a remote processing unit operatively coupled with the processor.

According to an embodiment, the method further comprises reordering using the processor the plurality of items using the generated hierarchical tree structure to provide an ordered list of items and rearranging using the processor the generated covariance matrix using the ordered list of items.

According to an embodiment, the indication of the determined weight allocation for each item in the group comprising a plurality of items is provided to a user interacting with the processor.

According to an embodiment, the indication of the determined weight allocation for each item in the group comprising a plurality of items is stored in a memory unit comprised in the processor.

According to an embodiment, the indication of the determined weight allocation for each item in the group comprising a plurality of items is provided to a remote processing unit operatively coupled with the processor.

According to an embodiment, each item is an asset and the group comprising a large plurality of items is a portfolio comprising a large plurality of assets and the plurality of data of a given item comprises a value of the asset over time.

According to a broad aspect, there is disclosed a digital computer comprising a central processing unit; a display device; a communication port for operatively connecting the digital computer to an analog computer comprising a quantum processor; a memory unit comprising an application for determining a weight allocation in a group comprising a large plurality of items, the application comprising instructions for obtaining an indication of a plurality of data for each item of a large plurality of items; instructions for generating a covariance matrix for the plurality of data; instructions for generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters, translating the formulated optimization problem into an unconstrained binary optimization problem, providing an indication of the unconstrained binary optimization problem to the analog computer, receiving an indication of at least one solution from the analog computer, assigning a cluster to each item of the given set of items using the at least one solution; instruction for recursively determining a weight allocation for each item of the large plurality of items using the covariance matrix and the generated hierarchical tree structure and instructions for providing an indication of the determined weight allocation for each item in the group comprising a plurality of items.

According to a broad aspect, there is disclosed a non-transitory computer readable storage medium for storing computer-executable instructions which, when executed, cause a digital computer to perform a method for determining a weight allocation in a group comprising a large plurality of items using an optimization oracle, the method comprising obtaining using a digital computer an indication of a plurality of data for each item of a large plurality of items; generating using the digital computer a covariance matrix for the plurality of data; generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters using the digital computer, translating using the digital computer the formulated optimization problem into an unconstrained binary optimization problem, providing using the digital computer an indication of the unconstrained binary optimization problem to an optimization oracle, receiving an indication of at least one solution from the optimization oracle using the digital computer, using the digital computer assigning a cluster to each item of the given set of items using the at least one solution; using the digital computer, recursively determining a weight allocation for each item of the plurality of items using the covariance matrix and the generated hierarchical tree structure; and providing using the digital computer an indication of the determined weight allocation for each item in the group comprising a plurality of items.

According to a broad aspect, there is disclosed a method for operating a system comprising a digital computer and an optimization oracle coupled to the digital computer to determine a weight allocation in a group comprising a large plurality of items, the method comprising obtaining using a digital computer an indication of a plurality of data for each item of a large plurality of items; generating using the digital computer a covariance matrix for the plurality of data; generating a hierarchical tree structure having a plurality of clusters, each cluster having a corresponding item associated therewith, the generating comprising there is one item associated per cluster of the hierarchical tree structure, recursively formulating an optimization problem to divide a given set of items into two different clusters using the digital computer, translating using the digital computer the formulated optimization problem into an unconstrained binary optimization problem, providing using the digital computer an indication of the unconstrained binary optimization problem to an optimization oracle, solving the unconstrained binary optimization problem using the optimization oracle, receiving an indication of at least one solution from the optimization oracle using the digital computer, using digital computer assigning a cluster to each item of the given set of items using the at least one solution; using the digital computer, recursively determining a weight allocation for each item of the plurality of items using the covariance matrix and the generated hierarchical tree structure; and providing using digital computer an indication of the determined weight allocation for each item in the group comprising a plurality of items.

An advantage of the method disclosed is that the determined weight allocation minimizes a risk measure, such as for instance variance. In the case where the items are assets, the determined weight allocation will help minimizing the associated risk which could be in one embodiment a variance of returns.

An advantage of the method disclosed is that it provides higher quality results in a shorter amount of time than prior art methods for determining weight allocation for large set of data. The efficiency of a system implementing the method disclosed herein is therefore greatly enhanced.

Another advantage of the method disclosed herein is that it does not need the covariance matrix to be non-singular.

It will be appreciated that another advantage of the method disclosed is that it is more stable against numerical errors since the method disclosed does not involve inverting the covariance matrix.

Another advantage of the method disclosed is that it provides a more diversified weight allocation; hence a more diversified portfolio of items.

### BRIEF DESCRIPTION OF THE DRAWINGS

In order that the invention may be readily understood, embodiments of the invention are illustrated by way of example in the accompanying drawings.

FIG. 1 is a flowchart that shows an embodiment of a method for determining a weight allocation in a group comprising a large plurality of items using an optimization oracle;

FIG. 2 is a flowchart that shows an embodiment for creating a hierarchical tree structure;

FIG. 3 is a flowchart that shows an embodiment of an optional step for reordering the items using the tree structure to provide an order list of items;

FIG. 4a is a flowchart that shows an embodiment of a method for updating the weight allocation recursively based on the rearranged covariance matrix;

FIG. 4b is a flowchart that shows another embodiment of a method for updating the weight allocation;

FIG. 5 is a flowchart that shows an embodiment of a method for setting the leaf as the parent and dividing it into two clusters of items;

FIG. 6 is a flowchart that shows an embodiment for calculating the variance for one of the two nodes;

FIG. 7 is a diagram that illustrates an example of a correlation matrix computed for a group comprising six items;

FIG. 8 is a diagram that illustrates an example of a covariance matrix computed for the group comprising six items;

FIG. 9 is a diagram that shows an embodiment of a hierarchical clustering tree generated for the group comprising six items;

FIG. 10 is a diagram that shows a reordered list for the group comprising six items;

FIG. 11 is a diagram that shows an embodiment of a rearranged covariance matrix generated for the group comprising six items;

FIG. 12 is a diagram that shows an embodiment of allocation of weight for the group comprising six items; and

FIG. 13 is a block diagram which shows an embodiment of a system which may be used to implement a method for determining a weight allocation in a group comprising a large plurality of items using an optimization oracle.

Further details of the invention and its advantages will be apparent from the detailed description included below.

### DETAILED DESCRIPTION OF THE INVENTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain.

The term “i.e.” and like terms mean “that is,” and thus limit the terms or phrases they explain.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, the present invention is directed to a method and a system for determining a weight allocation in a group comprising a large plurality of items using an optimization oracle.

It will be appreciated that the purpose of the method disclosed is to provide a weight allocation that will minimize a risk measure, such as variance for instance.

It will be appreciated that the method disclosed may be advantageously used for generating weight allocation for an asset portfolio. In the case where the items are assets, the determined weight allocation will help minimizing the associated risk which in one embodiment could be the variance of returns.

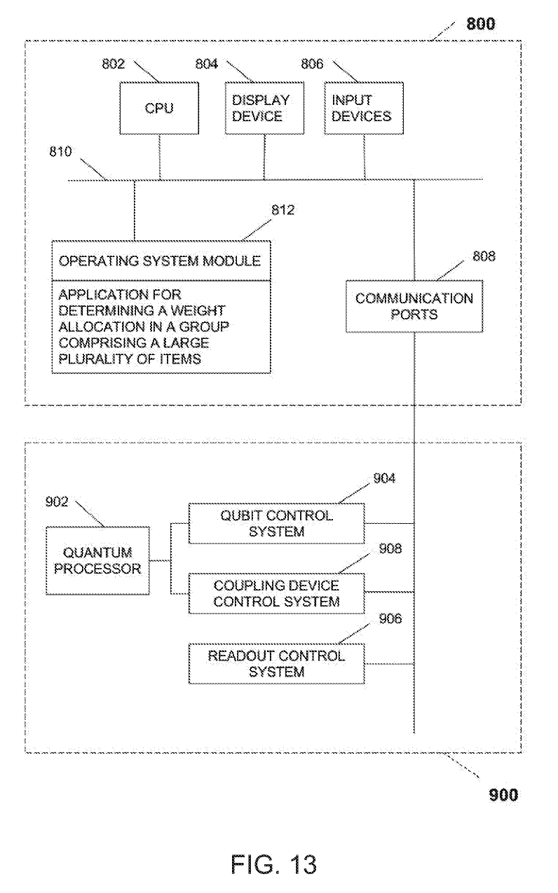

Now referring to FIG. 13, there is shown an embodiment of a system which may be used for implementing a method for determining a weight allocation in a group comprising a large plurality of items using an optimization oracle.

More precisely, the system comprises a digital computer 800 coupled to an analog computer 900. It will be appreciated that the analog computer 900 is optional since in one embodiment the method may be implemented using only the digital computer 800, as further explained below.

It will be appreciated that the digital computer 800 may be any type of digital computer.

In one embodiment, the digital computer 800 is selected from a group consisting of desktop computers, laptop computers, tablet PC's, servers, smartphones, etc. It will also be appreciated that, in the foregoing, the digital computer 8 may also be broadly referred to as a processor.

In the embodiment shown in FIG. 13, the digital computer 800 comprises a central processing unit 802, also referred to as a microprocessor, a display device 804, input devices 806, communication ports 808, a data bus 810 and a memory 812.

The central processing unit 802 is used for processing computer instructions. The skilled addressee will appreciate that various embodiments of the central processing unit 802 may be provided.

In one embodiment, the central processing unit 802 comprises a CPU Core i5 3210 running at 2.5 GHz and manufactured by Intel™.

The display device 804 is used for displaying data to a user. The skilled addressee will appreciate that various types of display device 804 may be used.

In one embodiment, the display device 804 is a standard liquid crystal display (LCD) monitor.

The input devices 806 are used for inputting data into the digital computer 800.

The communication ports 808 are used for sharing data with the digital computer 8.

The communication ports 808 may comprise, for instance, universal serial bus (USB) ports for connecting a keyboard and a mouse to the digital computer 800.

The communication ports 808 may further comprise a data network communication port such as IEEE 802.3 port for enabling a connection of the digital computer 800 with an analog computer 900.

The skilled addressee will appreciate that various alternative embodiments of the communication ports 808 may be provided.

The memory unit 812 is used for storing computer-executable instructions.

The memory unit 812 may comprise a system memory such as a high-speed random access memory (RAM) for storing system control program (e.g., BIOS, operating system module, applications, etc.) and a read-only memory (ROM).

It will be appreciated that the memory unit 812 comprises, in one embodiment, an operating system module.

It will be appreciated that the operating system module may be of various types.

In one embodiment, the operating system module is OS X Yosemite manufactured by Apple™.

The memory unit 812 further comprises an application for determining a weight allocation in a group comprising a large plurality of items using an optimization oracle.

The memory unit 812 may further comprise an application for using the analog computer 900 when the analog computer 900 is used as an optimization oracle.

The memory unit 812 may further comprise quantum processor data such as a corresponding weight for each coupler of the quantum processor 902 and a corresponding bias for each qubit of the quantum processor 902.

The analog computer 900 comprises a qubit control system 904, a readout control system 906, a quantum processor 902, and a coupling device control system 908.

The skilled addressee will appreciate that the analog computer 900 is an embodiment of an optimization oracle.

It will be further appreciated that the quantum processor 902 may be of various types. In one embodiment, the quantum processor comprises superconducting qubits. In fact, it will be appreciated that a quantum computer may comprise one or more quantum annealers, lsing solvers, optical parametric oscillators (OPOs), or gate models of quantum computing.

The readout control system 906 is used for reading the qubits of the quantum processor 902. In fact, it will be appreciated that in order for a quantum processor to be used in the method disclosed herein, a readout system that measures the qubits of the quantum system in their quantum mechanical states is required. Multiple measurements provide a sample of the states of the qubits. The results from the readings are fed to the digital computer 800. The biases of the qubits of the quantum processor 902 are controlled via the qubit control system 904. The couplers are controlled via the coupling device control system.

It will be appreciated that the readout control system 26 may be of various types. For instance, the readout control system 906 may comprise a plurality of dc SQUID magnetometers, each inductively connected to a different qubit of the quantum processor 902. The readout control system 906 may provide voltage or current values. In one embodiment, the dc SQUID magnetometer comprises a loop of superconducting material interrupted by at least one Josephson junction, as is well known in the art.

In another embodiment, the optimization oracle is implemented on a digital computer. For instance, the optimization oracle may be an implementation of Simulated Quantum Annealing. This is a method that approximately simulates the quantum annealing performed by a physical quantum annealing device.

It will be further appreciated that the digital computer on which the optimization oracle is implemented may be the digital computer 800 in a first embodiment. In a second embodiment, the digital computer on which the optimization oracle is implemented is a digital computer operatively coupled to the digital computer 800. The digital computer may be operatively coupled to the digital computer 800 using various means. In one embodiment, the coupling is achieved via a data network. The data network may be selected from a group consisting of a local area network (LAN), a metropolitan area network (MAN) and a wide area network (WAN). In one embodiment, the data network comprises the Internet.

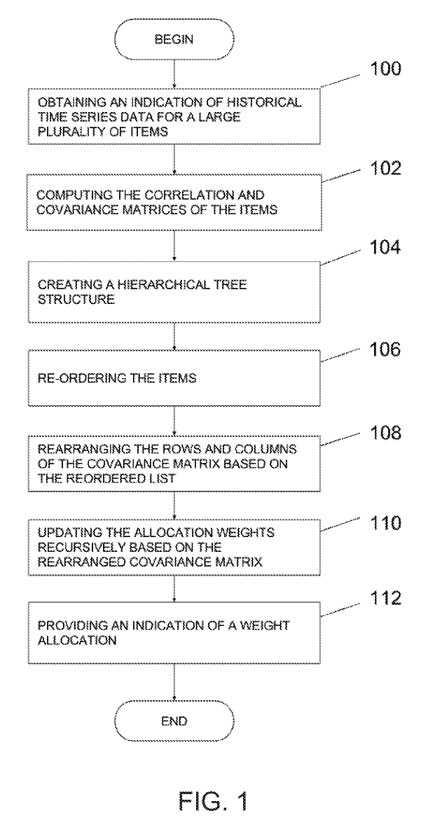

Now referring to FIG. 1, there is shown an embodiment of a method for determining a weight allocation in a group comprising a large plurality of items using an optimization oracle.

In one embodiment, each item is an asset and the group comprising a large plurality of items comprises a portfolio comprising the plurality of assets.

It will be appreciated that for instance the asset may be any financially tradable item.

According to processing step 100, an indication of historical time series data is obtained for a large plurality of items.

It will be appreciated that the obtaining of an indication of historical time series data for a large plurality of items is an embodiment of the processing step of obtaining an indication of a plurality of data for each item of a large plurality of items.

It will be appreciated that the obtaining of an indication of a plurality of data for each item of a large plurality of items may be performed according to various embodiments.

In one embodiment, the indication of a plurality of data for each item of a large plurality of items is obtained from a user interacting with the digital computer 800.

In another embodiment, the indication of a plurality of data for each item of a large plurality of items is obtained from the memory unit 812 of the digital computer 800.

In another alternative embodiment, the indication of a plurality of data for each item of a large plurality of items is obtained from a remote processing unit operatively coupled with the digital computer 800.

Similarly, it will be appreciated that the indication of historical time series data may be obtained according to various embodiments.

In one embodiment, the indication of historical time series data is obtained from a user interacting with the digital computer 800.

In an alternative embodiment, the indication of historical time series data is obtained from the memory unit 812 of the digital computer 800.

In another alternative embodiment, the indication of historical time series data is obtained from a remote processing unit operatively coupled with the digital computer 800.

It will be appreciated that the historical time series data may be of various types depending on the item.

For instance, in the case where the item is an asset, the historical time series data may comprise a value of the asset over time.

Still referring to FIG. 1 and according to processing step 102, the correlation and covariance matrices for the plurality of items are computed. While this processing step is disclosed in FIG. 1, it will be appreciated that more broadly a covariance matrix is generated for the plurality of data. It will be further appreciated that the covariance matrix is generated using the digital computer 800.

In the embodiment where the correlation and the covariance matrices are generated for the plurality of items, it will be appreciated by the skilled addressee that the matrices may be computed according to various embodiments.

It will be appreciated that the distance matrix may be obtained using any function of the historical time series data. In one embodiment, the distance matrix is obtained by applying an element wise function to a correlation matrix.

In one embodiment, the correlation and the covariance matrices are computed using the digital computer 800.

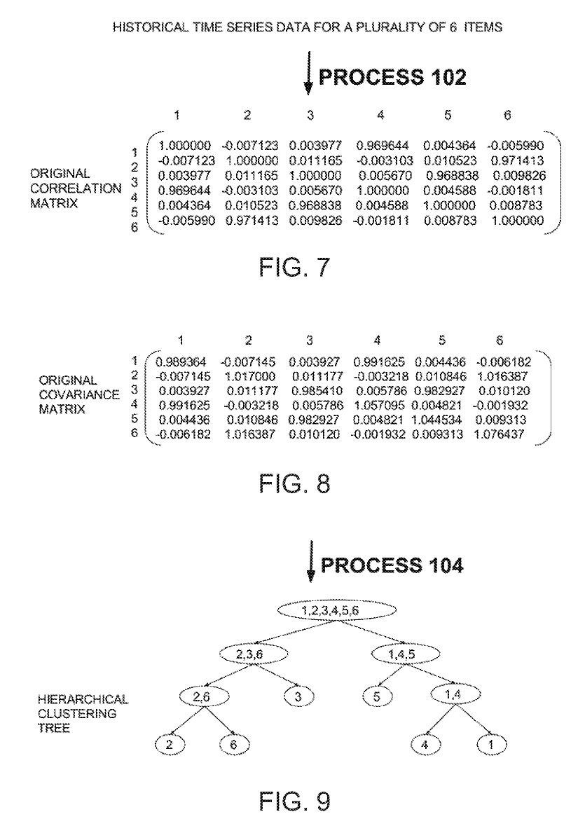

Now referring to FIGS. 7 and 8, there are shown respectively a correlation matrix and a covariance matrix for a group of a plurality of items comprising six items. It will be appreciated that FIGS. 7 and 8 are illustrating examples of matrices for a group of a very small set of items and are provided for illustration purposes only. It should be appreciated by the skilled addressee that the method disclosed herein is of great advantage for a large plurality of items.

As mentioned above, it will be appreciated that the computing of the correlation matrix is optional.

Now referring back to FIG. 1 and according to processing step 104, a hierarchical tree structure comprising each item of the large plurality of items is generated. It will be appreciated that the generating of a hierarchical tree structure may be performed according to various embodiments. In fact, it will be appreciated that the hierarchical tree structure comprises a plurality of clusters, each cluster has a corresponding item associated therewith. In one embodiment, the generating of the hierarchical tree structure comprises until there is one item associated per cluster of the hierarchical tree structure, recursively formulating an optimization problem to divide a given set of items into two different clusters using the digital computer 800, translating using the digital computer 800 the formulated optimization problem into an unconstrained binary optimization problem, providing using the digital computer 800 an indication of the unconstrained binary optimization problem to an optimization oracle, solving the unconstrained binary optimization problem using the optimization oracle, receiving an indication of at least one solution from the optimization oracle using the digital computer 800 and assigning a cluster to each item of the given set of items using the digital computer 800 and using the at least one solution.

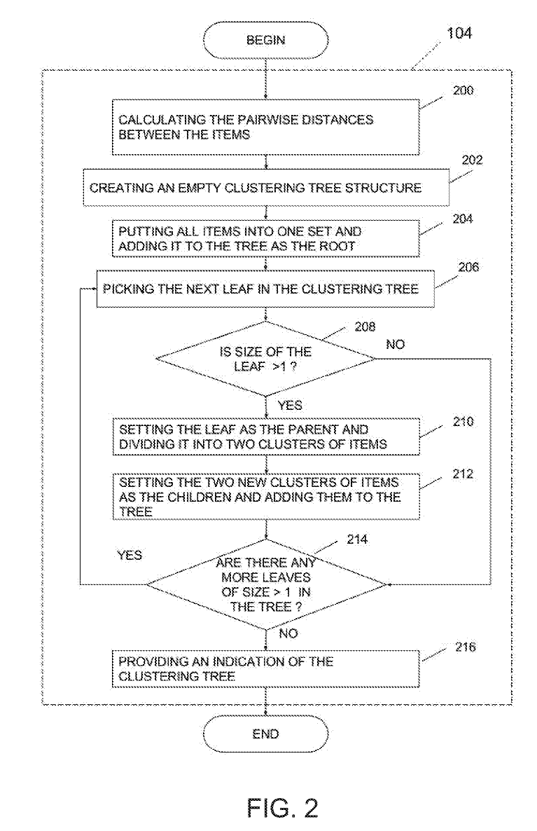

Now referring to FIG. 2, there is shown another embodiment for creating the hierarchical tree structure. In this embodiment, the hierarchical tree structure is also created using the digital computer 800.

According to processing step 200, pairwise distances are computed between the items based on correlations.

The skilled addressee will appreciate that the correlation matrix computed according to processing step 102 may be used for that purpose.

According to processing step 202, an empty tree structure is created.

As a matter of fact, it will be appreciated that the tree structure is a specific data structure used for storing the hierarchy of clusters. When created, the tree structure is empty but when it is used its size becomes dependent on the number of items comprised in the group.

According to processing step 204, all items are put into one set and it is added to the tree as the root.

According to processing step 206, a next leaf in the tree structure is picked.

According to processing step 208, a test is performed in order to find out if the size of the leaf is greater than one (1).

In the case where the size of the leaf is greater than one (1) and according to processing step 210, the leaf is set as the parent and divided into two clusters of items.

It will be appreciated that the division into two clusters of the items may be performed according to various embodiments.

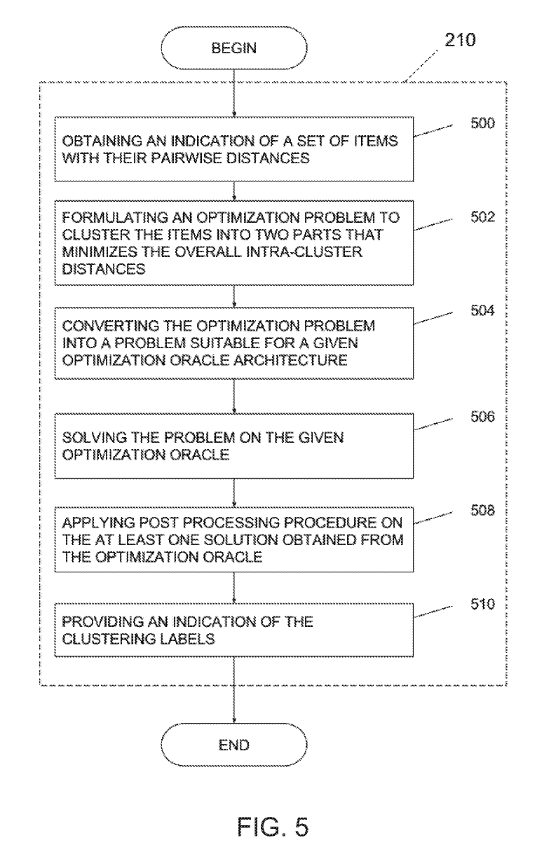

Now referring to FIG. 5, there is shown one embodiment for setting the leaf as the current and dividing the items into two clusters of items.

According to processing step 500, an indication of a set of items with their pairwise distances is obtained. It will be appreciated that the pairwise distances may be computed using the covariance matrix as mentioned above. In an alternative embodiment, the pairwise distances may be provided as an input.

According to processing step 502, an optimization problem is formulated to cluster the items into two parts that minimize the overall intra-cluster distances.

It will be appreciated by the skilled addressee that in one embodiment, the clustering of a subset of items into two clusters can be formulated as the following quadratic binary optimization problem:

$${min}_{x} {\sum }_{i = 1}^{2} ( {\sum }_{j , k} {x}_{ij} {x}_{ik} {d}_{jk} )$$

$$s . t . {\sum }_{i = 1}^{2} {x}_{ij} = 1 , ∀ j \leq N$$

where, xᵢⱼ is the binary decision variable and is equal to 1 if the item j is assigned to be in cluster i and it is 0, otherwise, wherein N is the total number of items to be clustered, and dⱼₖ is the element on the j'th row and k'th column of the distance matrix D which corresponds to the distance between items k and j. In one embodiment, this quadratic binary optimization problem is transformed into a quadratic unconstrained binary optimization (QUBO) problem. It will be appreciated that the quadratic unconstrained binary optimization is an embodiment of an unconstrained binary optimization problem. The quadratic unconstrained binary optimization (QUBO) problem is solved with a quadratic unconstrained binary optimization problem solver oracle. In one embodiment, the optimization oracle comprises the D-Wave quantum annealing machine manufactured by D-Wave systems in Burnaby, BC.

According to processing step 504, the optimization problem is converted into a problem suitable for a given optimization oracle architecture.

In fact, it will be appreciated that in one embodiment, a quantum annealer, such as the analog computer 900, may be used as an optimization oracle, while in another embodiment, the digital computer 800 may be used as an optimization oracle as explained above.

According to processing step 506, the optimization problem is solved using the given optimization oracle selected.

In the case where the analog computer 900 is used, the solving comprises setting up the analog computer 900 accordingly. The solving further comprises providing an indication of the unconstrained binary optimization problem to the analog computer 900, solving the unconstrained binary optimization problem using the analog computer 900 and obtaining an indication of at least one solution from the analog computer 900.

According to processing step 508, a post-processing procedure is applied on the at least one solution provided by the optimization oracle.

It will be appreciated by the skilled addressee that the purpose of the post-processing procedure is to improve the at least one solution provided by the optimization oracle if this is possible. For instance a simple heuristic local search may be used for that purpose. It is important to note that if the optimization oracle finds the optimal answer, the answer cannot be further improved.

Also, according to the processing step 504, sometimes the unconstrained binary optimization problem has to be transformed in order to make it compatible for a given optimization oracle, so when the at least one solution is received from the optimization oracle, the at least one solution may need to be translated back to become a valid indication of an answer for the unconstrained binary optimization problem.

In the case where the D-Wave machine is used as an optimization oracle, the result is a binary vector of 0 and 1s. This result must therefore be post-processed to extract the items in each cluster suggested by the binary vector.

According to processing step 510, an indication of the clustering labels is provided.

It will be appreciated that the indication of the clustering labels may be provided according to various embodiments.

Now referring back to FIG. 2 and according to processing step 212, the two new clusters of items are set as children and added to the clustering tree.

According to processing step 214, a test is performed in order to find out if there are any more leaves of size greater than one (1) in the clustering tree.

In the case where there is at least one leaf of size greater than one (1) in the clustering tree and according to processing step 206, the next leaf is picked in the clustering tree.

In the case where there is not one leaf of size greater than one (1) in the clustering tree and according to processing step 216, an indication of the hierarchical clustering tree is provided.

It will be appreciated by the skilled addressee that the indication of the hierarchical clustering tree may be of various types.

Now referring to FIG. 9, there is illustrated an example of a hierarchical clustering tree. This exemplary hierarchical clustering tree is built for the group comprising six (6) items. Again, it will be appreciated that this example is provided for illustration purpose. The method disclosed herein is used for a large plurality of items.

Now referring back to FIG. 1 and according to processing step 106, the items are reordered.

It will be appreciated by the skilled addressee that this processing step is optional as further explained below.

It will be appreciated that the items are reordered using the digital computer 800.

It will be appreciated that the purpose of the reordering is to place highly correlated items close together. It will be appreciated that rearranging the covariance matrix based on this reordering list makes a new covariance matrix that is quasi-diagonalized. The skilled addressee will appreciate that a quasi-diagonalized matrix is a matrix in which larger elements are closer to the diagonal. In fact, it will be appreciated that this processing step may be used for visualization purposes, by a user in one embodiment, in order to see how quasi-diagonalized matrix looks like. It will be appreciated that the items may be reordered according to various embodiments.

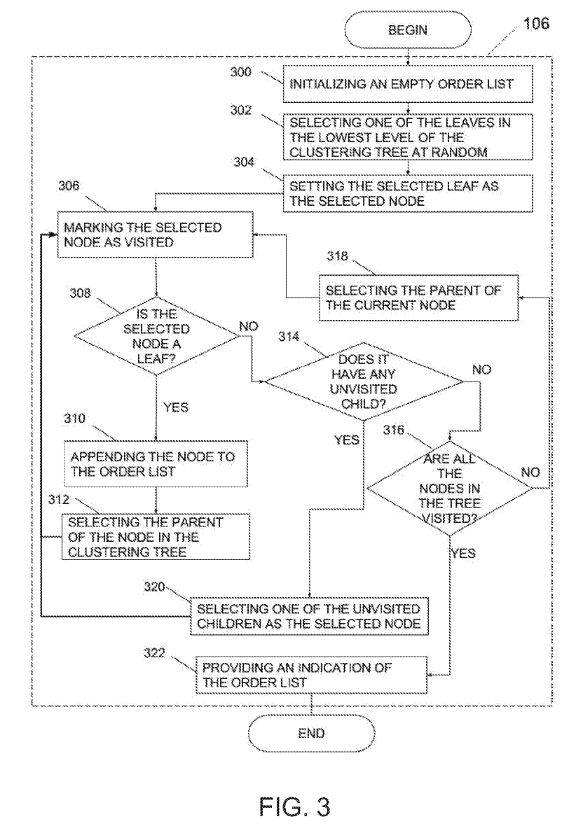

Now referring to FIG. 3, there is shown one embodiment for reordering the items. The skilled addressee will appreciate that various alternative embodiments may be used.

According to processing step 300, an empty order list is initialized.

According to processing step 302, one of the leaves is selected in the lowest level of the clustering tree at random.

According to processing step 304, the selected leaf is set as the selected node.

According to processing step 306, the selected node is marked as visited.

According to processing step 308, a test is performed in order to find out if the selected node is a leaf.

In the case where the selected node is a leaf and according to processing step 310, the node is appended to the ordered list. [000156] According to processing step 312, the parent of the node of the clustering tree is selected.

In the case where the selected node is not a leaf and according to processing step 314, a test is performed in order to find out if the node has an unvisited child. In the case where it has an unvisited child and according to processing step 320, an unvisited child is selected as the selected node.

In the case where it does not have an unvisited child and according to processing step 316, a test is performed in order to find out if all the nodes of the tree have been visited.

In the case where not all the nodes of the clustering tree have been visited and according to processing step 318, the parent of the current node is selected.

In the case where all nodes in the clustering tree and according to processing step 322, an indication of the ordered list is provided.

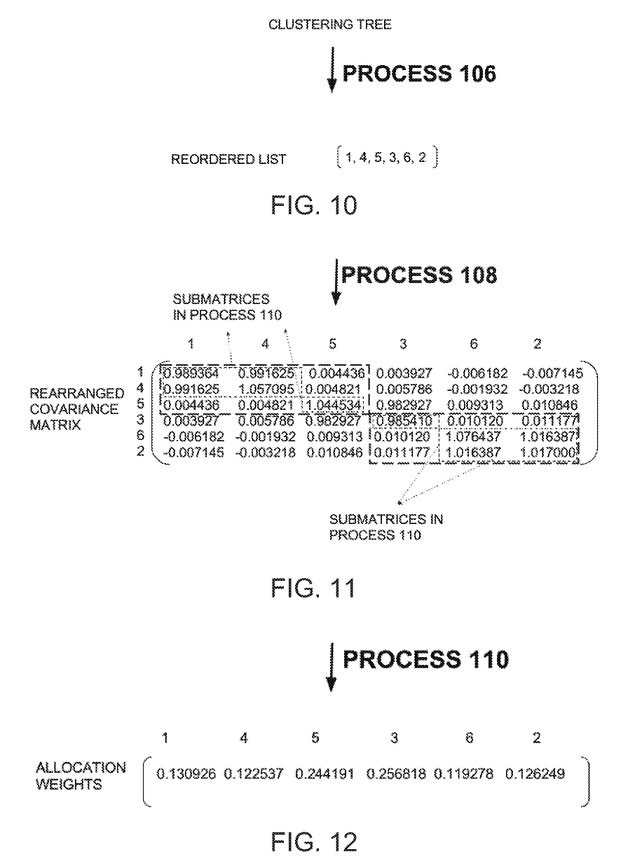

Now referring to FIG. 10, there is shown an example of the ordered list for the group of six items.

Now referring back to FIG. 1 and according to processing step 108, the rows and columns of the covariance matrix are rearranged based on the reordered list made according to processing step 106. It will be further appreciated that this processing step is optional.

Now referring to FIG. 11, there is shown an example of the rearranged covariance matrix for the group of six items.

Now referring back to FIG. 1 and according to processing step 110, the weight allocation is updated recursively based on the rearranged covariance matrix generated according to processing step 108 and the generated hierarchical tree structure.

It will be appreciated that more broadly, the weight allocation for each item of the large plurality of items is determined using the covariance matrix and the generated hierarchical tree structure.

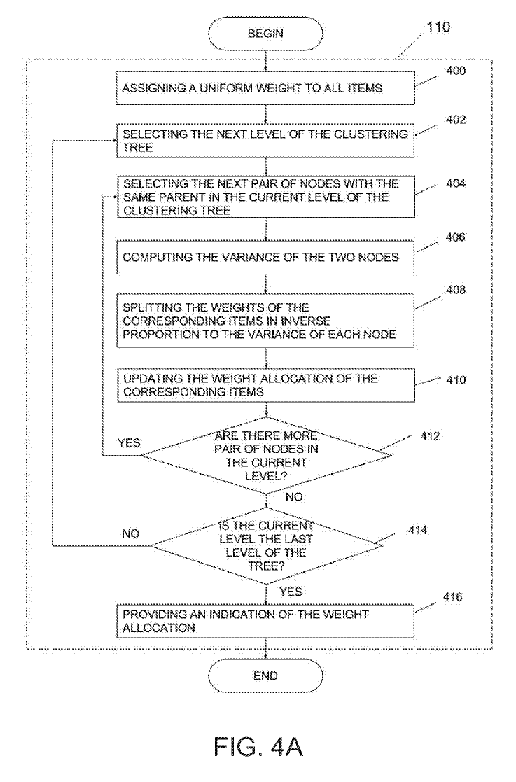

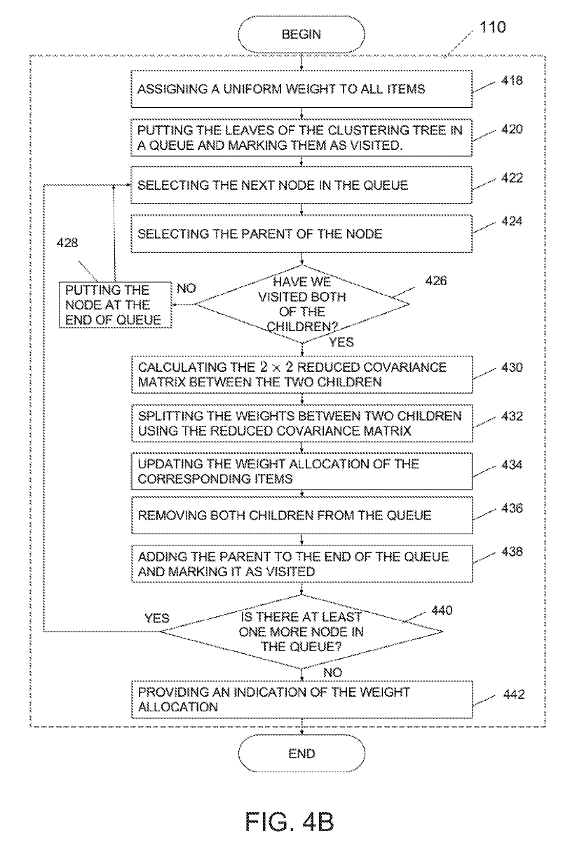

Now referring to FIG. 4a, there is shown an embodiment of a method for updating the weight allocation recursively based on the rearranged covariance matrix. It will be appreciated by the skilled addressee that the method disclosed herein uses a top-down strategy. As further detailed below the method begins by assigning a unit weight to all of the items, then as one moves down the clustering tree, at each level of the tree, the weights of items in each cluster are rescaled in inverse proportion to the cluster's variance.

It will be appreciated that in one embodiment, the updating of the weight allocation is performed using the digital computer 800.

More precisely and according to processing step 400, a uniform weight is assigned to all items of the large plurality of items.

According to processing step 402, the next level of the clustering tree is selected.

According to processing step 404, the next pair of nodes with the same parent in the current level of the clustering tree is selected.

According to processing step 406, the variance of the two nodes is computed.

It will be appreciated that the variance of the two nodes may be computed according to various embodiments. In one embodiment, the variance of the two nodes is computed using the digital computer 800.

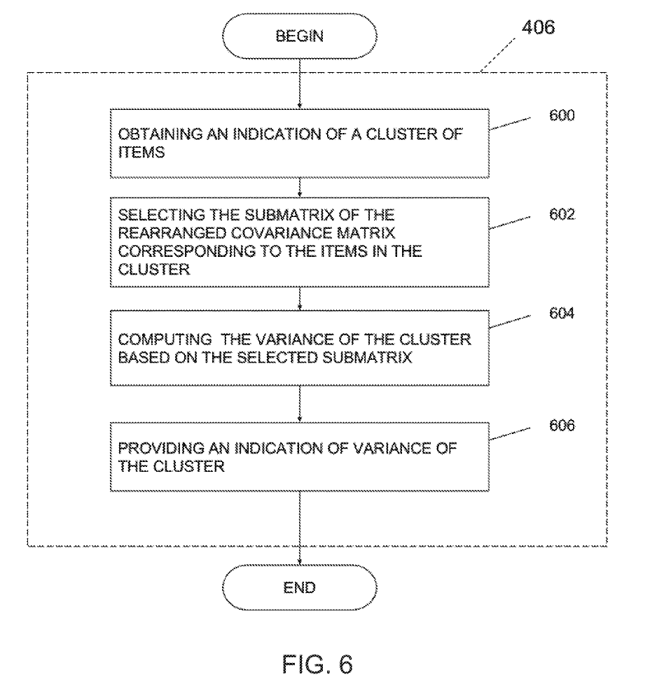

Now referring to FIG. 6, there is shown an embodiment for calculating the variance for one of the two nodes.

According to processing step 600, an indication of a cluster of items is obtained.

According to processing step 602, the submatrix of the rearranged covariance matrix corresponding to the items in the cluster is selected. In the case where the covariance matrix is not rearranged, the processing step is performed using the order list obtained according to the processing steps disclosed in FIG. 3.

According to processing step 604, the variance of the cluster is computed based on the selected submatrix.

According to processing step 606, an indication of a variance of the cluster is provided.

Now referring back to FIG. 4 and according to processing step 408, the weights of the corresponding items are split in inverse proportion to the variance of each node.

According to processing step 410, the weight allocation of the corresponding items is updated.

According to processing step 412, a test is performed in order to find out is there are more pairs of nodes in the current level.

In the case where there are more pairs of nodes in the current level and according to processing step 404, the next pair of nodes with the same parent in the current level of the clustering tree is selected.

In the case where there are no other pair of nodes in the current level and according to processing step 404, a test is performed in order to find out if the current level is the last level of the clustering tree.

In the case where the current level is not the last level of the clustering tree and according to processing step 402, the next level of the clustering tree is selected.

In the case where the current level of the clustering tree is the last level of the clustering tree and according to processing step 416, an indication of the weight allocation is provided.

Now referring to FIG. 4b, there is shown another embodiment of a method for updating the weight allocation. It will be appreciated that a unit weight is first assigned to all of the items. Then the processing starts with the leaves and it moves up the clustering tree, at each node is defined a two by two reduced covariance matrix between the two children of the node and it is used to calculate how to split the weights between two clusters (children). The weights of the items are then rescaled in each cluster according to the split factor. It will be appreciated that this method enables the use of many different methods for splitting the weights. One way is again to split the weights in inverse proportion to each cluster's variance similar as top-down strategy. Another way is to use the well-known mean-variance method to split the weights.

More precisely and according to processing step 418, a uniform weight is assigned to all items.

According to processing step 420, the leaves of the clustering tree are put in a queue and are marked as visited.

According to processing step 422, the next node in the queue is selected.

According to processing step 424, the parent of the node is selected.

According to processing step 426, a test is performed in order to find out if both of the children have been visited.

In the case where both of the children have not been visited and according to processing step 428, the node is put at the end of the queue.

In the case where both of the children have been visited and according to processing step 430, a 2×2 reduced covariance matrix between the two children is calculated.

According to processing step 432, the weights are split between the two children using the reduced covariance matrix.

According to processing step 434, the weight allocation of the corresponding items is updated.

According to processing step 436, both children are removed from the queue.

According to processing step 438, the parent is added to the end of the queue and is marked as visited.

According to processing step 440, a test is performed in order to find out if there are mode nodes in the queue.

In the case where there is at least one more node in the queue and according to processing step 422, the next node in the queue is selected.

In the case where there is not at least one more node in the queue and according to processing step 442, an indication of the weight allocation is provided.

Now referring back to FIG. 1 and according to processing step 112, an indication of the weight allocation is provided.

It will be appreciated that the indication of the weight allocation may be provided according to various embodiments.

In one embodiment, the indication of the weight allocation is provided to a user interacting with the digital computer 800.

In an alternative embodiment, the indication of the weight allocation is stored in the memory unit of the digital computer 800.

In another alternative embodiment, the indication of the weight allocation is transmitted to a remote processing unit operatively coupled with the digital computer 800.

It will be appreciated that the application for determining a weight allocation in a group comprising a large plurality of items using an optimization oracle which is stored in the memory unit 812 may comprise instructions for obtaining using the digital computer 800 an indication of a plurality of data for each item of a large plurality of items.

The application for determining a weight allocation in a group comprising a large plurality of items using an optimization oracle which is stored in the memory unit 812 may further comprise instructions for generating using the digital computer 800 a covariance matrix for the plurality of data.

The application for determining a weight allocation in a group comprising a large plurality of items using an optimization oracle which is stored in the memory unit 812 may further comprise instructions for generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters using the digital computer 800, translating using the digital computer 800 the formulated optimization problem into an unconstrained binary optimization problem, providing using the digital computer 800 an indication of the unconstrained binary optimization problem to an optimization oracle, receiving an indication of at least one solution from the optimization oracle using the digital computer 800, using the digital computer 800 assigning a cluster to each item of the given set of items using the at least one solution.

The application for determining a weight allocation in a group comprising a large plurality of items using an optimization oracle which is stored in the memory unit 812 may further comprise instructions for using the digital computer 800, recursively determining a weight allocation for each item of the plurality of items using the covariance matrix and the generated hierarchical tree structure.

The application for determining a weight allocation in a group comprising a large plurality of items using an optimization oracle which is stored in the memory unit 812 may further comprise instructions for providing using the digital computer 800 an indication of the determined weight allocation for each item in the group comprising a plurality of items.

It will be appreciated that a non-transitory computer-readable storage medium is further disclosed for storing computer-executable instructions which, when executed, cause a digital computer to perform a method for determining a weight allocation in a group comprising a large plurality of items using an optimization oracle, the method comprising generating using the digital computer a covariance matrix for the plurality of data; generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters using the digital computer, translating using the digital computer the formulated optimization problem into an unconstrained binary optimization problem, providing using the digital computer an indication of the unconstrained binary optimization problem to an optimization oracle, receiving an indication of at least one solution from the optimization oracle using the digital computer, using the digital computer assigning a cluster to each item of the given set of items using the at least one solution; using the digital computer, recursively determining a weight allocation for each item of the plurality of items using the covariance matrix and the generated hierarchical tree structure and providing using the digital computer an indication of the determined weight allocation for each item in the group comprising a plurality of items.

It will be appreciated that a method for operating a system comprising a digital computer and an optimization oracle coupled to the digital computer is also disclosed. The method for operating a system comprising a digital computer and an optimization oracle is used for determining a weight allocation in a group comprising a large plurality of items. The method comprises obtaining using a digital computer an indication of a plurality of data for each item of a large plurality of items; generating using the digital computer a covariance matrix for the plurality of data; generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters using the digital computer, translating using the digital computer the formulated optimization problem into an unconstrained binary optimization problem, providing using the digital computer an indication of the unconstrained binary optimization problem to an optimization oracle, solving the unconstrained binary optimization problem using the optimization oracle, receiving an indication of at least one solution from the optimization oracle using the digital computer, using digital computer assigning a cluster to each item of the given set of items using the at least one solution; using the digital computer, recursively determining a weight allocation for each item of the plurality of items using the covariance matrix and the generated hierarchical tree structure; and providing using digital computer an indication of the determined weight allocation for each item in the group comprising a plurality of items.

Although the above description relates to a specific preferred embodiment as presently contemplated by the inventors, it will be understood that the invention in its broad aspect includes functional equivalents of the elements described herein.

1. A method for determining a weight allocation in a group comprising a large plurality of items using an optimization oracle, the method comprising:
obtaining using a processor an indication of a plurality of data for each item of a large plurality of items;
generating using the processor a covariance matrix for the plurality of data;
generating a hierarchical tree structure having a plurality of clusters, each cluster having a corresponding item associated therewith, the generating comprising:
until there is one item associated per cluster of the hierarchical tree structure,
recursively formulating an optimization problem to divide a given set of items into two different clusters using the processor,
translating using the processor the formulated optimization problem into an unconstrained binary optimization problem,
providing using the processor an indication of the unconstrained binary optimization problem to an optimization oracle,
receiving an indication of at least one solution from the optimization oracle using the processor,
using the processor assigning a cluster to each item of the given set of items using the at least one solution;
using the processor, recursively determining a weight allocation for each item of the plurality of items using the covariance matrix and the generated hierarchical tree structure; and
providing using the processor an indication of the determined weight allocation for each item in the group comprising a plurality of items.

2. The method as claimed in claim 1, wherein the indication of a plurality of data for each item of a large plurality of items is obtained from a user interacting with the processor.

3. The method as claimed in claim 1, wherein the indication of a plurality of data for each item of a large plurality of items is obtained from a memory unit comprised in the processor.

4. The method as claimed in claim 1, wherein the indication of a plurality of data for each item of a large plurality of items is obtained from a remote processing unit operatively coupled with the processor.

5. The method as claimed in claim 1, further comprising reordering using the processor the plurality of items using the generated hierarchical tree structure to provide an ordered list of items and rearranging using the processor the generated covariance matrix using the ordered list of items.

6. The method as claimed in claim 1, wherein the indication of the determined weight allocation for each item in the group comprising a plurality of items is provided to a user interacting with the processor.

7. The method as claimed in claim 1, wherein the indication of the determined weight allocation for each item in the group comprising a plurality of items is stored in a memory unit comprised in the processor.

8. The method as claimed in claim 1, wherein the indication of the determined weight allocation for each item in the group comprising a plurality of items is provided to a remote processing unit operatively coupled with the processor.

9. The method as claimed in claim 1, wherein each item is an asset and the group comprising a large plurality of items is a portfolio comprising a large plurality of assets; further wherein the plurality of data of a given item comprises a value of the asset over time.

10. A digital computer comprising:
a central processing unit;
a display device;
a communication port for operatively connecting the digital computer to an analog computer comprising a quantum processor;
a memory unit comprising an application for determining a weight allocation in a group comprising a large plurality of items, the application comprising:
instructions for obtaining an indication of a plurality of data for each item of a large plurality of items;
instructions for generating a covariance matrix for the plurality of data;
instructions for generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters, translating the formulated optimization problem into an unconstrained binary optimization problem, providing an indication of the unconstrained binary optimization problem to the analog computer, receiving an indication of at least one solution from the analog computer, assigning a cluster to each item of the given set of items using the at least one solution;
instruction for recursively determining a weight allocation for each item of the large plurality of items using the covariance matrix and the generated hierarchical tree structure; and
instructions for providing an indication of the determined weight allocation for each item in the group comprising a plurality of items.

11. A non-transitory computer readable storage medium for storing computer-executable instructions which, when executed, cause a digital computer to perform a method for determining a weight allocation in a group comprising a large plurality of items using an optimization oracle, the method comprising:
obtaining using a digital computer an indication of a plurality of data for each item of a large plurality of items;
generating using the digital computer a covariance matrix for the plurality of data;
generating a hierarchical tree structure having a plurality of clusters, each cluster having a corresponding item associated therewith, the generating comprising until there is one item associated per cluster of the hierarchical tree structure, recursively formulating an optimization problem to divide a given set of items into two different clusters using the digital computer, translating using the digital computer the formulated optimization problem into an unconstrained binary optimization problem, providing using the digital computer an indication of the unconstrained binary optimization problem to an optimization oracle, receiving an indication of at least one solution from the optimization oracle using the digital computer, using the digital computer assigning a cluster to each item of the given set of items using the at least one solution;
using the digital computer, recursively determining a weight allocation for each item of the plurality of items using the covariance matrix and the generated hierarchical tree structure; and
providing using the digital computer an indication of the determined weight allocation for each item in the group comprising a plurality of items.

12. A method for operating a system comprising a digital computer and an optimization oracle coupled to the digital computer to determine a weight allocation in a group comprising a large plurality of items, the method comprising:
obtaining using a digital computer an indication of a plurality of data for each item of a large plurality of items;
generating using the digital computer a covariance matrix for the plurality of data;
generating a hierarchical tree structure having a plurality of clusters, each cluster having a corresponding item associated therewith, the generating comprising:
until there is one item associated per cluster of the hierarchical tree structure,
recursively formulating an optimization problem to divide a given set of items into two different clusters using the digital computer,
translating using the digital computer the formulated optimization problem into an unconstrained binary optimization problem,
providing using the digital computer an indication of the unconstrained binary optimization problem to an optimization oracle,
solving the unconstrained binary optimization problem using the optimization oracle,
receiving an indication of at least one solution from the optimization oracle using the digital computer,
using digital computer assigning a cluster to each item of the given set of items using the at least one solution;
using the digital computer, recursively determining a weight allocation for each item of the plurality of items using the covariance matrix and the generated hierarchical tree structure; and
providing using digital computer an indication of the determined weight allocation for each item in the group comprising a plurality of items.
